(19) United States
(12) Patent Application Publication
(10) Pub. No.: US 2005/0152372 A1
(43) Pub. Date: Jul. 14, 2005

(54) System and method for performing transmission and reception operations based on broadcast/communication convergence

(76) Inventors: Sang-Ho Kim, Suwon-si (KR); Yong-Deok Kim, Seoul (KR); Yun-Je Oh, Yongin-si (KR); Jun-Ho Koh, Suwon-si (KR); Kyu-Hyung Cho, Bucheon-si (KR)

Correspondence Address: CHA & REITER, LLC, 210 ROUTE 4 EAST STE 103, PARAMUS, NJ, 07652, US

(21) Appl. No.: 10/991,182

(22) Filed: Nov. 17, 2004

(30) Foreign Application Priority Data
Jan. 13, 2004 (KR) 2004-2280
Aug. 18, 2004 (KR) 2004-65101

(51) Int. Cl. H04L 12/28

(52) U.S. Cl. 370/395.1; 370/401

(57) ABSTRACT

A system for performing transmission and reception operations based on broadcast/communication convergence. A transmitter adapted for the broadcast/communication convergence converts input broadcast data into a parallel format, inserts port identification (Port ID) information into each of the broadcast data converted into the parallel format and input communication data, multiplexes the broadcast data and the communication data, and transmits a broadcast/communication convergence signal based on a result of the multiplexing through a single transmission channel. A receiver adapted for the broadcast/communication convergence demultiplexes the broadcast/communication convergence signal using the Port ID information to be separated into the broadcast data and the communication data when the broadcast/communication convergence signal is received, and outputs data to a corresponding destination.

### CLAIM OF PRIORITY

This application claims priorities to an application entitled “SYSTEM AND METHOD FOR PERFORMING TRANSMISSION AND RECEPTION OPERATIONS BASED ON BROADCAST/COMMUNICATION CONVERGENCE”, filed in the Korean Intellectual Property Office (KIPO) on Jan. 13, 2004 and assigned Serial No. 2004-2280, and to another application with the same invention title filed in the KIPO on Aug. 18, 2004 and assigned Serial No. 2004-65101, respectively, the contents of which are hereby incorporated by reference.

### BACKGROUND OF THE INVENTION

1. Field of the Invention

The present invention relates to a system and method for performing transmission and reception operations based on broadcast/communication convergence that can transmit both broadcast data and Ethernet data together. More particularly, the present invention relates to a system and method for performing transmission and reception operations based on broadcast/communication convergence that can transmit broadcast data and Ethernet data through a single transmission line.

2. Description of the Related Art

With increased technological development in the arts, there has been a great increase in information technologies, with communication developing into a form in which data, voice and video are all integrated. Therefore, it is expected that the boundary between broadcast, communication and video industries is not distinct and hence will be developing into one integrated form. In particular, it is expected that this phenomenon will be accelerated by the advent of digital broadcast.

Most data to be digitized into broadcast data is video data. Such data is often formatted into data streams, such as in Moving Picture Experts Group-2 (MPEG-2). With the development of MPEG into a form in which broadcast and communication are integrated, a device for performing a transmission operation based on broadcast/communication convergence can transmit both broadcast data and communication data together.

The conventional device for performing a transmission operation based on broadcast/communication convergence separates broadcast data (such as MPEG-2 data) and communication data (such as Ethernet data) from each other, and the conventional device transmits a result of the separation. Here, the MPEG-2 data and the Ethernet data are multiplexed by means of a packet switching method on a transmitting side and a packet resulting from the multiplex of data is transmitted. A receiving side separates the result of the multiplexed data packets into broadcast data (such as MPEG-2 data) and communication data (such as Ethernet data) by using the packet identification (PID) information found in formats such as MPEG-2 data.

FIG. 1 is a schematic block diagram illustrating a conventional device 20 for performing a transmission operation based on broadcast/communication convergence.

As shown in FIG. 1, the conventional device 20 that performs transmission operations based on broadcast/communication convergence can accommodate communication data transmitted through the Internet 10, satellite broadcast data transmitted from a satellite, and cable broadcast data transmitted by a cable.

A router 21 receives communication data that is transmitted through the Internet 10. In other words, this data is Ethernet data. The received Ethernet data is transmitted to an asynchronous transfer mode (ATM) switch 22. The ATM switch 22 selectively outputs input Ethernet data to a broadcast/communication multiplexer 29 according to control of a system manager 23.

A satellite broadcast receiver (receiving device) 25 receives satellite broadcast data transmitted from a satellite reception antenna and transmits the received satellite broadcast data to a video controller 24 and/or an MPEG-2 encoder 27. A cable broadcast receiver 26 receives cable broadcast data transmitted from a broadcast station and transmits the received cable broadcast data to the MPEG-2 encoder 27.

The MPEG-2 encoder 27 encodes the broadcast data transmitted from the satellite broadcast receiver 25 and the cable broadcast receiver 26. In other words, the satellite broadcast data the cable broadcast data are encoded as MPEG-2 data, and then the encoded MPEG-2 data is transmitted to an MPEG-2 multiplexer 28. The MPEG-2 multiplexer 28 multiplexes the MPEG-2 data transmitted from the MPEG-2 encoder 27 and then transmits the multiplexed MPEG-2 data to the video controller 24.

The video controller 24 selectively outputs to the broadcast/communication multiplexer 29 the satellite broadcast data transmitted from the satellite broadcast receiver 25 and the multiplexed MPEG-2 data from the MPEG-2 multiplexer 28 according to the control of the system manager 23. The broadcast/communication multiplexer 29 multiplexes the communication data output from the ATM switch 22 and the satellite broadcast data output from the video controller 24 and then transmits a result of the multiplexing to a network 30.

In order that the conventional device 20 that performs a transmission operation based on broadcast/communication convergence can ensure a quality of service (QoS) of the broadcast data, a conversion to a plesiochronous digital hierarchy (PDH), synchronous digital hierarchy (SDH) or ATM format is carried out. Due to the fact that the Internet data is Ethernet data, the Ethernet data is again converted into time division multiplexing (TDM) data so that the broadcast/communication convergence can be performed. There is a problem in the conventional system shown in FIG. 1 in that bandwidth can be wasted and high priced TDM equipment is required in order that different formats of data units can be converted into the same format data units. Moreover, after the broadcast data is converted into TDM data and the Ethernet data is converted into TDM data, the TDM data units must be combined by a predetermined device.

In the above-mentioned arrangement, there is a drawback in that the subscriber side must be equipped with high priced equipment because a subscriber side requires the same devices as in the transmitting side.

### SUMMARY OF THE INVENTION

Therefore, the present invention has been made in view of at least some of the above problems and the present invention provides a system and method for performing transmission and reception operations based on broadcast/communication convergence that can simultaneously transmit broadcast data and Internet data through a single physical medium and provide lower priced equipment to each subscriber than known heretofore.

In accordance with the accomplishment of the aspects of the present invention, there is provided a system for performing transmission and reception operations based on broadcast/communication convergence, comprising a transmitter based on the broadcast/communication convergence for converting input broadcast data into a parallel format, adding port identification (Port ID) information to the broadcast data converted into the parallel format and input Ethernet data, multiplexing the broadcast data and the Ethernet data, and transmitting a broadcast/communication convergence signal multiplexed by the multiplexer through a single transmission channel. The system also comprises a receiver adapted for the broadcast/communication convergence for demultiplexing the multiplexed broadcast/communication convergence signal, using the Port ID information, to be separated into the broadcast data and the Ethernet data when the multiplexed broadcast/communication convergence signal is received and outputting corresponding data to a destination.

In accordance with another aspect of the present invention, there is provided a method for transmitting and receiving a broadcast/communication convergence signal using a system for performing transmission and reception operations based on broadcast/communication convergence, the system being equipped with a transmitter and receiver adapted for broadcast/communication convergence, comprising the steps of: (a) converting input broadcast data into a parallel format by a transmitter adapted for broadcast/communication convergence, adding port identification (Port ID) information to the broadcast data converted into the parallel format and input communication data, multiplexing the broadcast data and the input communication data, and transmitting a multiplexed broadcast/communication convergence signal based on a result of the multiplexing through a single transmission channel; and (b) demultiplexing the multiplexed broad/communication convergence signal, using the Port ID information, to be separated into the broadcast data and the communication data when the multiplexed broadcast/communication convergence signal is received, and outputting corresponding data to a destination.

### BRIEF DESCRIPTION OF THE DRAWINGS

The above aspects and other advantages of the present invention will be more clearly understood from the following detailed description taken in conjunction with the accompanying drawings, in which:

FIG. 1 is a schematic block diagram illustrating a conventional device for performing a transmission operation based on broadcast/communication convergence;

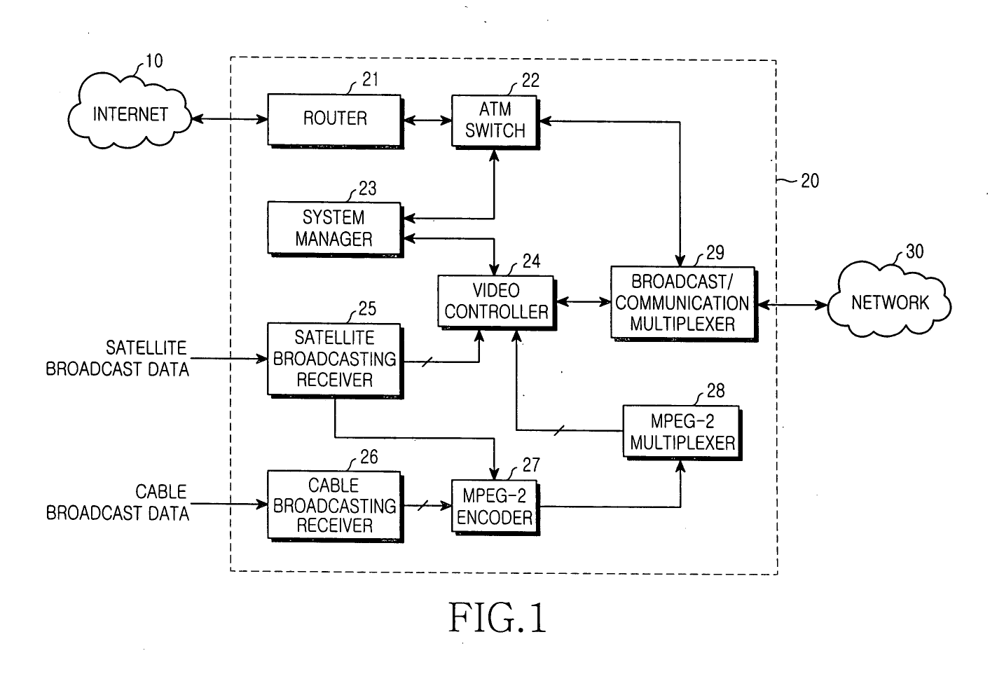

FIG. 2 shows a format of broadcast data;

FIG. 3 is a table illustrating an example of configuring packet identification (PID) information of the broadcast data of FIG. 2;

FIG. 4 is a hierarchical structure of an MPEG-4 system in accordance with one embodiment of the present invention;

FIG. 5 is a block diagram illustrating a system for performing a transmission operation based on broadcast/communication convergence in accordance with a first aspect of the present invention;

FIG. 6 is a hierarchical structure of a fiber channel in accordance with one embodiment of the present invention;

FIG. 7 is a schematic block diagram illustrating a system for performing a transmission operation based on broadcast/communication convergence in accordance with a second aspect of the present invention;

FIG. 8 is a graph illustrating a form of data acquired by components shown in FIG. 7;

FIG. 9 is a flow chart illustrating a method for transmitting and receiving a broadcast/communication convergence signal using a system for performing transmission and reception operations based on broadcast/communication convergence in accordance with a second aspect of the present invention;

FIG. 10 is a flow chart illustrating a detailed process of step S100 shown in FIG. 9; and

FIG. 11 is a flow chart illustrating a detailed process of step S300 shown in FIG. 9.

### DETAILED DESCRIPTION

Now, several aspects of the present invention will be described in detail with reference to the annexed drawings. In the drawings, the same or similar elements are denoted by the same reference numerals even though they are depicted in different drawings. In the following description made in conjunction with aspects of the present invention, a variety of specific items, such as concrete circuits are shown. The descriptions of such items have been made only for explanatory purposes, and not to limit the invention for use only with the items shown and described. Those skilled in the art will appreciate that the present invention can be implemented without using the above-mentioned specific items. Also, in the following description, a detailed description of known functions and configurations incorporated herein will be omitted when it may obscure the subject matter of the present invention.

First, when broadcast data is transmitted in accordance with a first embodiment of the present invention, a transmitting side multiplexes various broadcast data and Ethernet data to a single transmission line on an FPGA (Field Programmable Gate Array), and transmits the broadcast data through a physical layer transmission part such as a fiber channel, ESCON (Enterprise Systems Connection), etc. as well as a DVB ASI (Digital Video Broadcast-Asynchronous Serial Interface). A receiving side initiates an operation for separating received data into original broadcast data units and original Ethernet data.

Also, even though the international standard for digital broadcasting has adopted a MPEG-2 method, CODECs such as MPEG-4, MPEG-4 AVC (H.264) and Microsoft Windows Media ver. 9, etc. are commonly used by users, with increased technological development in video/audio compression. Also, in order that a general PC and mobile communication terminal may reproduce moving picture, MPEG-4 based CODEC is more commonly used than MPEG-2 based CODEC, since MPEG-4 has a relatively larger compression rate than MPEG-2. Also, with increased technological development in transmission/reception methods for transmitting/receiving various types of data and with increased transmission rate, chipsets capable of transmitting data with a transmission rate on the order of Gbps are commonly used by users. Therefore, broadcast data, as will be described in the first embodiment of the present invention, includes IP/Ethernet/data over MPEG-2, MPEG-4 data, H.264 data such as MPEG-4 AVC, data using MPEG-2 system standard, multimedia data requiring QoS (Quality of Service) and MPEG-2. Especially, a multiplexing method and transmission method of the second embodiment of the present invention are capable of implementing a variety of transmission rates using a serialized interface chipset of a physical layer. More specifically, a transmission method using a physical layer of fiber channel method including DVB ASI is disclosed. Also, transmission/reception standards for high rate serial interconnection include Ethernet, USB2, IEEE 1394, Serial ATA, PCI-X, XAUI, RapidIO, InfiniBand, etc. When MPEG-2 data of broadcast data is sent in accordance with a second embodiment of the present invention, a transmitting side multiplexes various broadcast data units and Ethernet data into a single transmission line on a DVB-ASI. A receiving side initiates an operation for separating a result of the multiplexing into original broadcast data units and Ethernet data. Here, low-priced FPGA and DVB ASIs may be employed.

Before a description is given of the present invention, the DVB ASI used in the second embodiment of the present invention will be briefly described.

An encoding principle and method used, for example, MPEG 2, was proposed and defined before the development of MPEG-2 technology. However, a method for physically transmitting MPEG-2 data from one piece of equipment to another has not been clearly defined for a predetermined time and hence equipment providers have used different methods. Physical interface standards such as a synchronous serial interface (SSI), a synchronous parallel interface (SPI), etc. based on Europe's DVB standard are currently defined. In the physical interface standards, the DVB ASI method is well known as a method for transmitting MPEG-2 data between digital TV-related broadcast devices.

The DVB ASI method asynchronously transmits an encoded stream based on 8B/10B bits at a fixed rate of 270 MBaud in a serial manner, and uses a coaxial cable of 75 ohm or a multimode optical fiber as a transmission medium. In this case, a transmission clock of the interface is fixed, and MPEG-2 data according to the clock can be variably selected within capacity of data that can be maximally transmitted. Because the transmission clock is fixed, there is a benefit in that a receiver can easily extract the clock and a structure of the receiver can be simplified.

Referring to the process for transmitting the MPEG-2 data to the ASI, data is encoded by means of 8B/10B channel coding, and the encoded data is asynchronously transmitted, such that comma characters called K28.5 are inserted into the head and tail of an MPEG-2 packet in order for a synchronization operation to be easily carried out. Therefore, because data is transmitted at a rate of 270 MBaud and encoded by means of the 8B/10B channel coding and K28.5 is inserted into the data, the maximum data transmission rate is 213.7 MBaud.

Meanwhile, a transmitter based on broadcast/communication convergence is designed so that broadcast data, Internet data, voice, etc. can be simultaneously transmitted to the subscriber side through one transmission line. Furthermore, a transmission operation by the subscriber side significantly affects cost. For this reason, broadcast data and a voice signal are typically transmitted through Internet data. However, this case has a problem in that QoS of a transmission signal is degraded.

To address the above-described problem, a need exists for a method for transmitting broadcast data and communication data while cost-effectively transmitting broadcast data, Internet data and voice and ensuring transmission signal quality. Because the broadcast data can have various transmission rates, a function relating to a transmission rate for the broadcast data is needed.

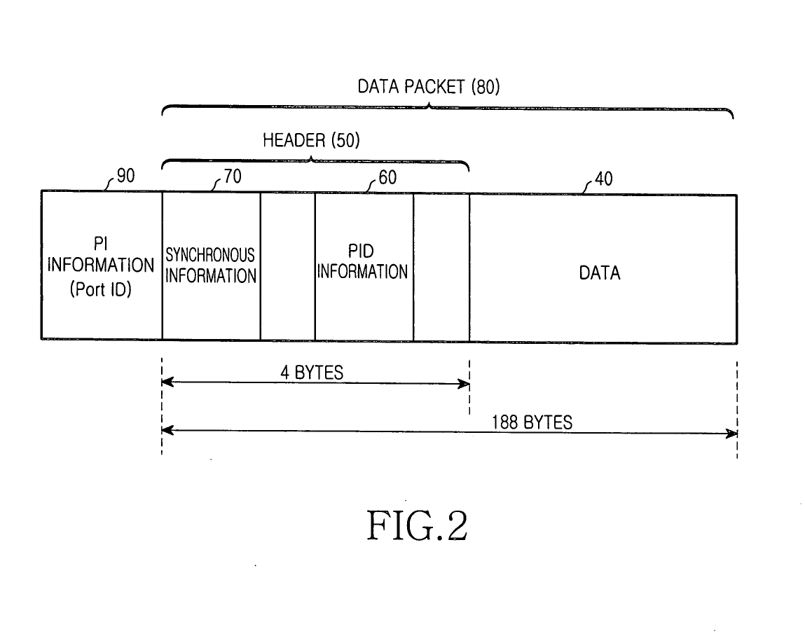

For example, a reference format of broadcast data such as MPEG-2 data can have a variable transmission rate. Thus, an algorithm for controlling a transmission rate of MPEG-2 data is needed, which will be described in detail below with reference to FIG. 2. FIG. 2 shows a format of broadcast data. Here, the broadcast data is described based on MPEG-2 data. As shown in FIG. 2, an MPEG-2 data packet 80 consists of 188 bytes, including MPEG-2 data 40 and a header 50. Here, the header consists of a total of 4 bytes, including synchronous information 70 and packet identification (PID) information 60.

The header 50 includes PID information 60 indicative of the type of data. Thus, a receiving side determines whether the received MPEG-2 data is video data, audio data, text data or etc. using the PID information 60.

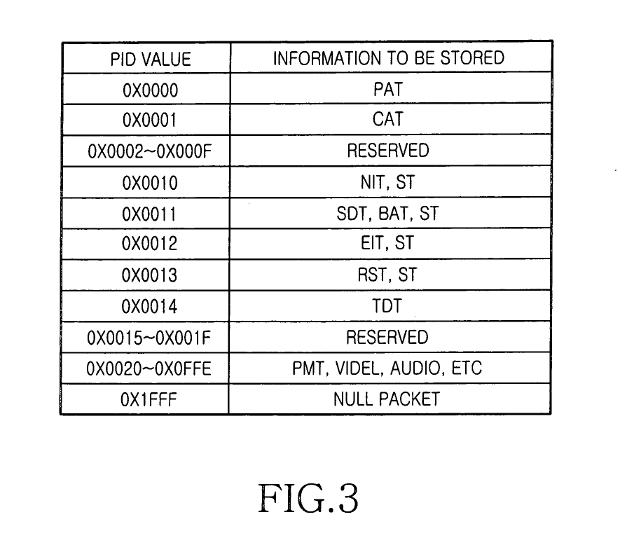

The PID information 60 can be configured as in the table of FIG. 3. FIG. 3 is a table illustrating an example of configuring the PID information of the MPEG-2 data. As shown in FIG. 3, a null packet having “0x1FFF” is present in the PID information. When receiving the null packet, an MPEG-2 decoder of a transmitting side ignores and discards the received null packet. When MPEG-2 data having a lower transmission rate are adjusted to a predetermined transmission rate using the above-described characteristic and are transmitted at the adjusted transmission rate, an actual transmission rate of the MPEG-2 data is not varied.

Furthermore, since the receiving side recognizes PID information of the null packet, the null packet can be removed on the basis of the PID information. Therefore, all MPEG-2 data units having a transmission rate lower than a reference rate can be stably transmitted without clock data recovery (CDR).

Meanwhile, when a single data packet 80 as mentioned above is inputted into a transmitter for performing a transmission operation based on broadcast/communication convergence through previously allocated ports thereof, then port identification (Port ID) information 90 based on 1 byte, corresponding to respective input ports, is added to a start portion of the data packet 80. Similarly, in the case that an Ethernet data packet is inputted into the transmitter, Port ID information based on 1 byte, corresponding to respective input ports, is added to a start portion of the Ethernet data packet 80. Namely, Port ID information is added to the start portion of each of the broadcast data packets and Ethernet data packets inputted into the transmitter for performing a transmission operation based on broadcast/communication convergence.

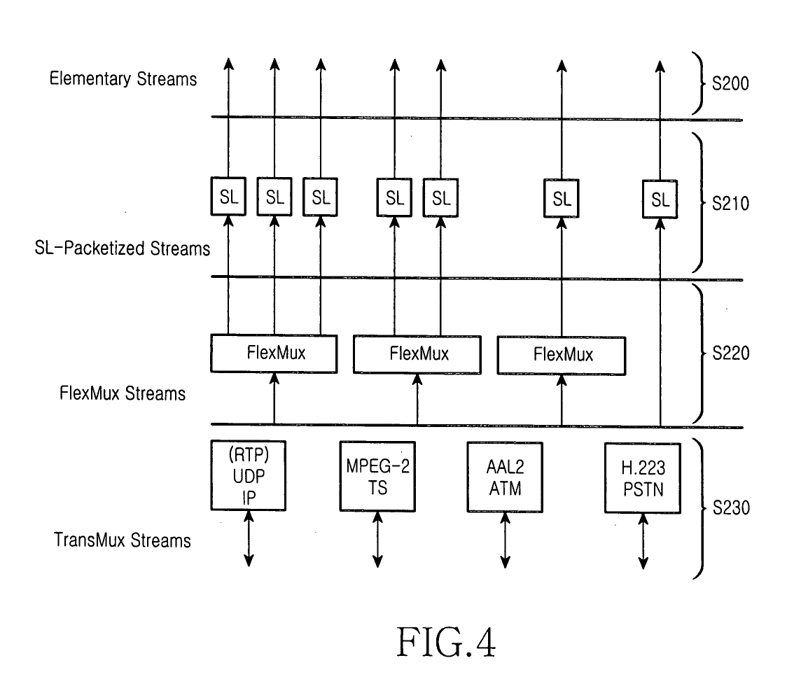

Now, operations for transmitting broadcast data through a system for performing a transmission operation based on broadcast/communication convergence will be described. FIG. 4 is a hierarchical structure of an MPEG-4 system in accordance with one embodiment of the present invention. Referring to FIG. 4, regarding MPEG-4 data, media objects, such as audio or video data, are separated into respective single objects, each of which is transmitted in element stream format. Namely, the element stream is transmitted based on a hierarchical structure as shown in FIG. 4. Here, the hierarchical structure of the MPEG-4 system includes a Compression Layer S200 for interfacing the elementary stream therewith, a Synchronous Layer S210 for interfacing a DMIF (Delivery Multimedia Integration Framework) application therewith, a DMIF Layer S220 for interfacing a DMIF network therewith, and a TransMux Layer S230.

First, DMIF defines a protocol capable of storing and transmitting multimedia data and API (Application Program Interface) to a variety of Transport Layers such as MPEG-2 TS (Transport Stream), IP, etc., within MPEG-4 data. The elementary stream configured based on respective object characteristics is packetized to comply with respective layers. The TransMux Layer S230 serves to support a transmission service while satisfying a predetermined QoS.

Since a specific transmission method is not defined for MPEG-4 data, it can be transmitted through a TCP/IP network, a network for an MPEG-2 system TS, an ATM network, PSTN, etc, as shown in FIG. 4. Here, the TCP/IP network and network for MPEG-2 system TS are typically used for transmitting data, which can be identically adapted to data processed by a H.264 CODEC having been developed from an MPEG-4 video encoder. Therefore, broadcast data as will be described later can be adapted to all data using methods for MPEG-2 data, MPEG-2 System data, MPEG-4 data, H.264 data, IP/Ethernet/data over MPEG-2, etc.

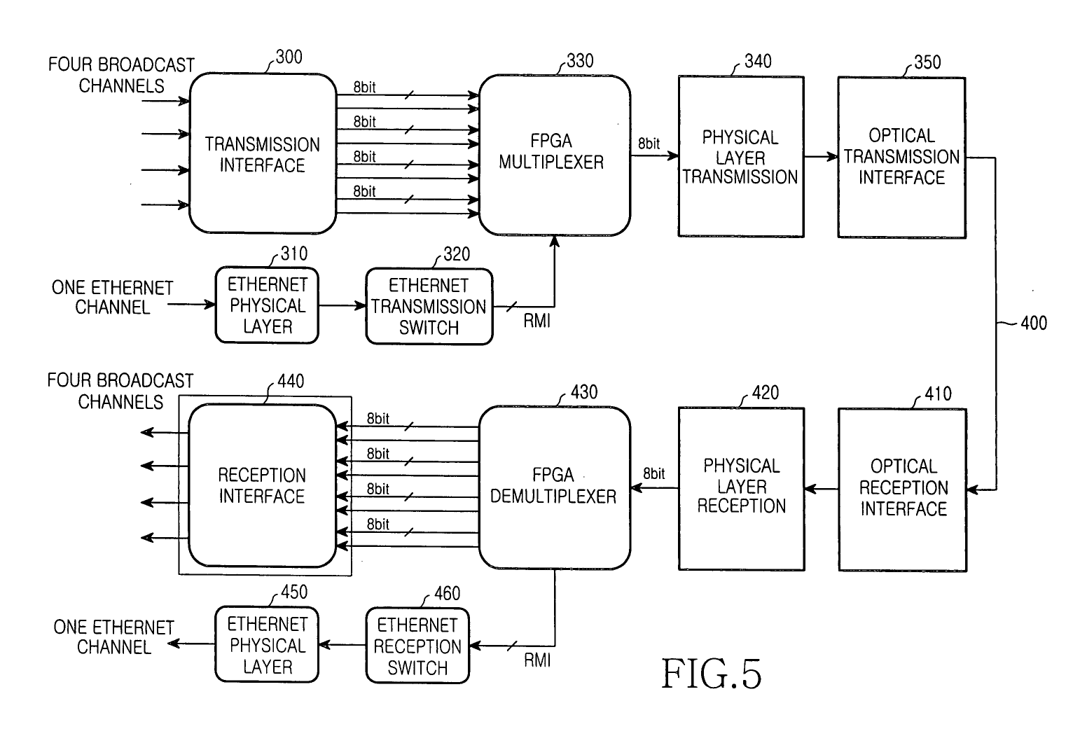

Operations for processing broadcast data and Ethernet data in a system for performing a transmission operation based on broadcast/communication convergence will be described with reference to FIG. 5.

FIG. 5 is a block diagram illustrating a system for performing a transmission operation based on broadcast/communication convergence in accordance with a first aspect of the present invention.

As shown in FIG. 5, the system for performing a transmission operation based on broadcast/communication convergence includes a transmitter adapted for broadcast/communication convergence for transmitting broadcast data and communication data through a single transmission channel and a receiver adapted for broadcast/communication convergence for receiving and recovering the broadcast data and communication data transmitted through the single transmission channel.

The above-described transmitter converts input broadcast data inputted from a plurality of ports into a parallel format, inserts Port ID information into the broadcast data based on the parallel format and input communication data, and multiplexes the broadcast data and the communication data, such that a multiplexed broadcast/communication convergence signal is transmitted through the single transmission channel.

More specifically, a transmitter adapted for broadcast/communication convergence for transmitting broadcast data and communication data corresponds to an OLT (Optical Line Terminal) or a multiplexer for transmitting broadcast data and communication data thereto. The transmitter includes a low-priced FPGA for multiplexing Ethernet data and broadcast data based on MPEG, MPEG-4, H.264 and MPEG-2 system standards, and a physical layer transmission part of a fiber channel for transmitting a result of the low-priced FPGA operation.

The PID information and the Port ID information will now be briefly described. The PID information is used for determining whether a type of broadcast data, such as MPEG-2, is video data, audio data, text data or etc. Accordingly, the PID information necessary for discriminating a type of broadcast data is added to the broadcast data packet input to the transmitter.

The Port ID information, as information applied to the present invention, can be used for determining whether data transmitted through a transmitter adapted for broadcast/communication convergence is broadcast data or Ethernet communication data. Also, the Port ID information is indicative of information of ports through which data is input to the transmitter.

When receiving the broadcast/communication convergence signal, the receiver adapted for broadcast/communication convergence separates the broadcast/communication convergence signal into broadcast data and communication data using the Port ID information, and outputs corresponding data to a destination. More specifically, the receiver corresponds to an OLT or a demultiplexer. The receiver includes a physical layer reception unit of a fiber channel for receiving data, and a low-priced FPGA for demultiplexing broadcast data and Ethernet data based on MPEG-2, MPEG-4, H.264 and the MPEG-2 system standards.

With reference to FIG. 5, operations for transmitting data in the transmitter based on broadcast/communication convergence will be described below. First, a transmission interface 300 converts broadcast data input through a plurality of channels into a parallel format based on units of predetermined bits, and outputs the converted data to the FPGA multiplexer 330 through a plurality of output ports. Here, the broadcast data includes MPEG data, H.264 data, IP/Ethernet/data over MPEG-2, etc, which are multimedia data using the MPEG-2 system standard.

When input communication data through the Ethernet channel is inputted to an Ethernet physical layer 310, an Ethernet transmission switch 320 performs a switching operation to output the transmitted communication data from the Ethernet physical layer 310, that is, Ethernet data, to the FPGA multiplexer 330. Here, in accordance with the first embodiment of the present invention, the Ethernet data can be transmitted via 100 Mbps Fast Ethernet, a plurality of Fast Ethernets or Gigabit Ethernet (GbE).

Then, an FPGA multiplexer 330 adds Port ID information necessary for discriminating each data unit to an additional portion, such as a start portion, of broadcast data and Ethernet data outputted from the transmission interface 300 and the Ethernet switch 320. Here, the Port ID information is indicative of information of a corresponding port through which data is input to the FPGA multiplexer 330.

The broadcast data and Ethernet data, each of which has the Port ID information added thereto, is temporarily stored in FIFO (First-In-First-Out) memories (not shown) previously allocated in a memory within the FPGA multiplexer 330. Here, the Ethernet data with the Port ID information added thereto and valid signals are stored in 9-bit FIFO memories together.

After that, if a data packet is stacked in a respective FIFO memory, the respective FIFO memory outputs an enable signal, indicating that the data packet is available, to the FPGA multiplexer 330. If a predetermined quantity of data is stacked in the FIFO memory storing Ethernet data, a confirmation operation of whether data effective signal stored therewith is ‘0’ is performed therein. If a time point when the data effective signal is ‘0’ is detected, an enable signal indicating that data stacked until the time point is available is outputted to the FPGA multiplexer 330. Then the FPGA multiplexer 330 reads, in order, corresponding data based on enable signals from the respective FIFO memories. If the enable signals occur at the same time point, the FPGA multiplexer 330 processes from the highest priority based on a predefined sequence of priorities. Here, the sequence of priorities is effective only if the enable signals occur at the same time point. However, except for the case that the enable signals occur at the same time point, the processing operations are performed based on the sequence of occurrence of the enable signals.

As such, the FPGA multiplexer 330 multiplexes broadcast data and Ethernet data, each of which has Port ID information added thereto, to a parallel format, and outputs the multiplexed data to a physical layer transmission 340 using the fiber channel method through a single channel when an enable signal occurs. Here the physical layer transmission 340 includes a DVB ASI. Then, the multiplexed data is converted into serial data (hereinafter, referred to as a broadcast/communication convergence signal) using a fast serial standard physical layer through a chipset of the physical layer transmission 340. The physical layer transmission 340 may use one of ESCON (Enterprises System Connection), DVB ASI channel, a fiber channel, or other suitable method.

An optical transmission interface 350 then converts the broadcast/communication convergence signal output from the physical layer transmission 340 into an optical signal, and transmits the optical signal to the receiver adapted for broadcast/communication convergence through a single transmission channel, that is, an optical fiber channel 400.

The physical layer transmission 340 according to the first embodiment of the present invention is implemented with a transceiver for optical channel, ESCON, or DVB ASI, whereby a serial line ratio of transmission line based on a few Gbps can be selectively used. Namely, as a chipset of the physical layer transmission utilizes external clocks, the transmission rate can be flexibly adjusted based on the transmission distance and usage.

For example, in case of Cypress' HOTLink II chipset generally used for fast serial link based on the one-to-one or one-to-multi method, an oscillator connected to a transceiver is replaced such that a serial line ratio can be selected based on 195 Mbps˜1.5 Gbps. Therefore, if a serial link chipset of another company also inputs clocks from an external oscillator, the serial line ratio of the serial link chipset can be selected based on 195 Mbps˜1.5 Gbps.

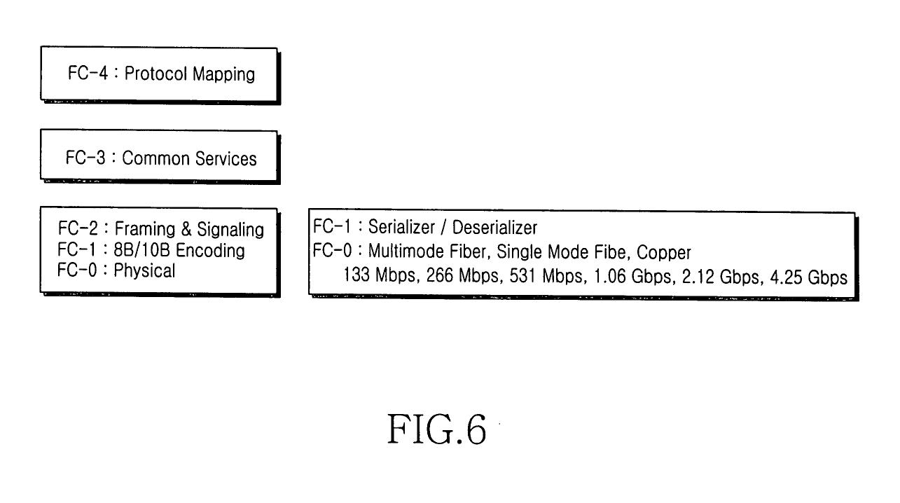

Before describing the operations for processing the broadcast/communication convergence signal in the receiver adapted for receiving the signal from the transmitter adapted for broadcast/communication convergence, a physical layer of a fiber channel used in the first embodiment of the present invention will be briefly described. With reference to FIG. 6, a hierarchical structure of a fiber channel in accordance with one embodiment of the present invention will be described.

As shown in FIG. 6, the hierarchical structure of the fiber channel includes 5 layers, from FC (Fiber Channel)-0 to FC-4. The present invention does not use all the layers of the optical channel, but utilizes FC-0 and FC-1 associated with transmission to use a commercial and low-priced chipset based on a physical layer transmission part, and FC-2 for filling idle intervals between packets with synchronous characters.

Here, the FC-0 as a physical layer is implemented with copper, and can be operated in multimode or single mode. The transmission rate can be selected from among 133 Mbps, 266 Mpbs, 512 Mbps, 1.06 Gbps, 2.12 Gbps and 4.25 Gbps. Data is encoded based on the 8B/10B channel encoding method of the FC-1. The FC-2 supports a chipset for high speed serial interface.

There are a variety of industrial standards for the chipset supporting high speed serial interface. These industrial standards commonly enable the chipset to endure the errors, and uses the 8B/10B channel encoding method for loading and transmitting clock signals to a single transmission line. These industrial standards allow a cable to be selected as a transmission medium or a photo module, etc., and have a protocol of a hierarchical structure to commonly use the physical layer, etc. Also, since these industrial standards serve to provide flow control methods for flexibly transmitting/receiving data, they can be adopted to various serial interface industrial standards as well as a fiber channel.

Now, there will be described a signal processing operation in the receiver adapted for broadcast/communication convergence into which the broadcast data and the communication data are converged by the system for performing transmission and reception operations based on broadcast/communication convergence.

The multiplexed transmitted data, i.e., the broadcast/communication convergence signal, is demultiplexed in the receiver adapted for broadcast/communication convergence. More specifically, an optical reception interface 410 receives a broadcast/communication convergence signal transmitted from the optical transmission interface 350 of the transmitter adapted for broadcast/communication convergence, converts the received signal into data in a parallel format, and provides the converted data in the parallel format to an FPGA demultiplexer 430 through a physical layer reception 420. Then, the FPGA demultiplexer 430 analyzes Port ID information, added to the converted data in the parallel format, so that the converted data is separated into broadcast data and Ethernet data, while the broadcast data and Ethernet data are identified by the respective ports based on a result of the analysis, and then removes the Port ID information therefrom.

In case of broadcast data in the FPGA demultiplexer 430, each data packet and an enable signal are stored in a FIFO memory together and then transferred to a decoding block to output them through the reception interface 440. In case of Ethernet data in the FPGA demultiplexer 430, Ethernet data is separated into an Ethernet data packet and a data effective signal, and 8 bits of parallel data is converted into MII (Media Independent Interface) data to then output them through an Ethernet reception switch 460 and an Ethernet physical layer 450.

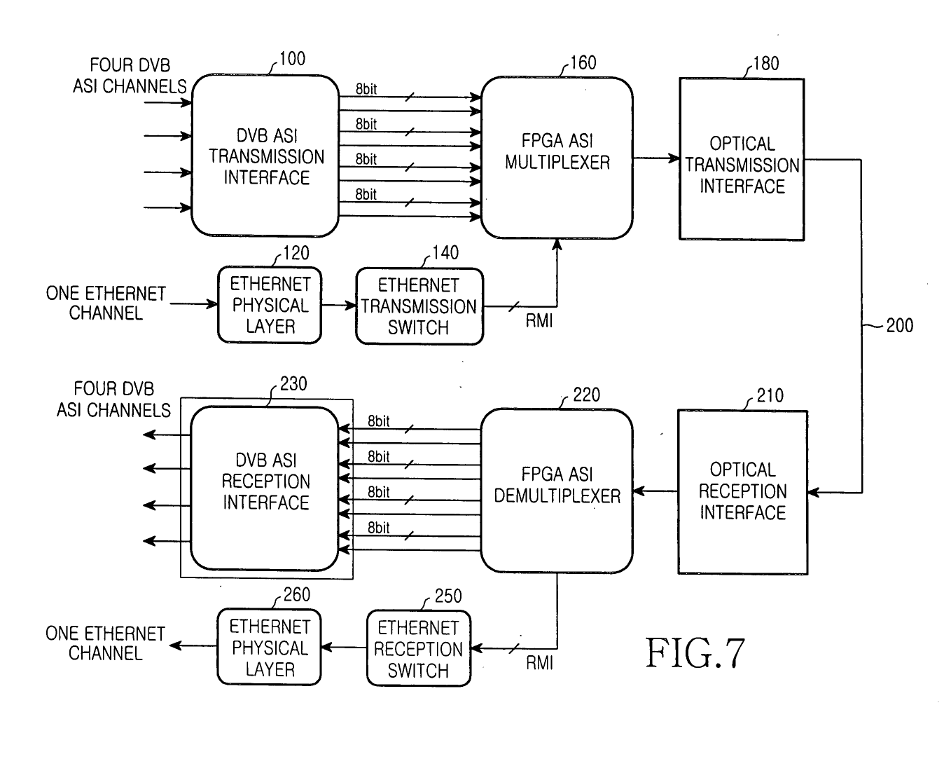

Based on MPEG-2 data of broadcast data, FIG. 7 is a block diagram illustrating a system for performing a transmission operation based on broadcast/communication convergence in accordance with a second aspect of the present invention.

The operation for transmitting data in the transmitter based on broadcast/communication convergence will be described with reference to FIG. 7. First, a DVB ASI transmission interface 100 converts input broadcast data, that is, MPEG-2 data, into a parallel format based on units of predetermined bits, and outputs the converted MPEG-2 data to a plurality of output ports. An Ethernet transmission switch 140 switches communication data transmitted from an Ethernet physical layer 120, that is, Ethernet data, and outputs the switched communication data.

A FPGA ASI multiplexer 160 inserts Port ID information necessary for discriminating each data unit into an additional portion of each of the MPEG-2 data and the Ethernet data output from the DVB ASI transmission interface 100 and the Ethernet transmission switch 140. The FPGA ASI multiplexer 160 multiplexes the MPEG-2 data and the Ethernet data into which the Port ID information is inserted, and outputs the multiplexed data (hereinafter, referred to as a broadcast/communication convergence signal) to one channel.

An optical transmission interface 180 converts the broadcast/communication convergence signal output from the FPGA ASI multiplexer 160 into an optical signal and transmits the optical signal to the receiver based on broadcast/communication convergence through one transmission channel, that is, an optical fiber channel 200.

Now, there will be described a signal processing operation in the receiver adapted for broadcast/communication convergence receiving the broadcast/communication convergence signal into which the broadcast data and the communication data are converged by the system for performing transmission and reception operations based on broadcast/communication convergence.

An optical reception interface 210 of the receiver receives the broadcast/communication convergence signal transmitted from the optical transmission interface 180 of the transmitter, converts the received broadcast/communication convergence signal into an electrical signal, and outputs the broadcast/communication convergence signal converted into the electrical signal.

An FPGA ASI demultiplexer 220 separates the broadcast/communication convergence signal output from the optical reception interface 210 into broadcast data, for example, MPEG-2 data, and communication data, such as, Ethernet data, using PI information. The FPGA ASI demultiplexer 220 outputs the MPEG-2 data and the Ethernet data through a plurality of different output ports.

A DVB ASI reception interface 230 converts the MPEG-2 data output through a number of output ports from the FPGA ASI demultiplexer 220 into a serial format and then outputs the converted MPEG-2 data to a corresponding destination.

An Ethernet reception switch 250 transmits the Ethernet data output from the FPGA ASI demultiplexer 220 to the corresponding destination through an Ethernet physical layer 260.

The FPGA ASI demultiplexer 220 separates the broadcast/communication convergence signal into MPEG-2 data and Ethernet data using the Port ID information and removes the Port ID information added to each of the MPEG-2 data and the Ethernet data. Thus, the FPGA ASI demultiplexer 220 outputs the MPEG-2 data and the Ethernet data, from which the Port ID information is removed, to the DVB ASI reception interface 230 and the Ethernet reception switch 250.

As a result, the transmitting side adds Port ID information necessary for discriminating types of data into each of the broadcast data and the communication data, multiplexes the broadcast data and the communication data into which the Port ID information units are added in one signal, and transmits the multiplexed signal through a single transmission line or channel. Then, the receiving side separates the multiplexed signal into the broadcast data and the communication data using the Port ID information and outputs each of the broadcast data and the communication data to a corresponding destination. The broadcast data and the communication data can be simultaneously received and transmitted through the single transmission line or channel.

As described in a second aspect of the present invention, the system for performing a transmission operation based on broadcast/communication convergence integrates MPEG-2 data and Ethernet data using ASI characteristics, and transmits the integrated MPEG-2 data and Ethernet data. In this case, a length of the MPEG-2 data containing voice data is fixed, while a length of the Ethernet data is variable. Furthermore, the Ethernet data ensures an inter frame gap (IFG) of 960 ns or more. Here, the IFG is to prevent exclusive channel occupancy.

A starting part of the Ethernet packet contains 8 bytes of a preamble necessary for matching transmission and reception rates of the transmitting and receiving sides. An end part of the Ethernet packet contains a 4-byte frame check sequence (FCS), that is, an error correction code. The FCS is used to check an error of the Ethernet packet data other than the preamble and the FCS.

An algorithm performed by the FPGA ASI multiplexer 160 shown in FIG. 7 is configured so that it can first process data that is first input. Here, the FPGA ASI multiplexer 160 of the transmitting side adds, to a header of the input data, one byte indicating a unique ID of the input data. Furthermore, the FPGA ASI multiplexer 160 of the transmitting side transmits the Ethernet data while maintaining an input IFG.

The FPGA ASI multiplexer 160 of the transmitting side determines whether or not an error is present in Ethernet data by checking an FCS. If an error is present, the FPGA ASI multiplexer 160 of the transmitting side stores error information in a memory provided inside the FPGA ASI multiplexer 160 of the transmitting side so that the stored information can be externally read. Moreover, the FPGA ASI multiplexer 160 of the transmitting side removes a preamble from the Ethernet data and then transmits a result of the removal. This is aimed to maintain the IFG for the Ethernet data in the demultiplexer of the receiving side having received the Ethernet data.

When data units are simultaneously input, the FPGA ASI multiplexer 160 of the transmitting side processes the input data units according to priorities, but the priorities sequentially vary and use an algorithm to prevent exclusive transmission line occupancy.

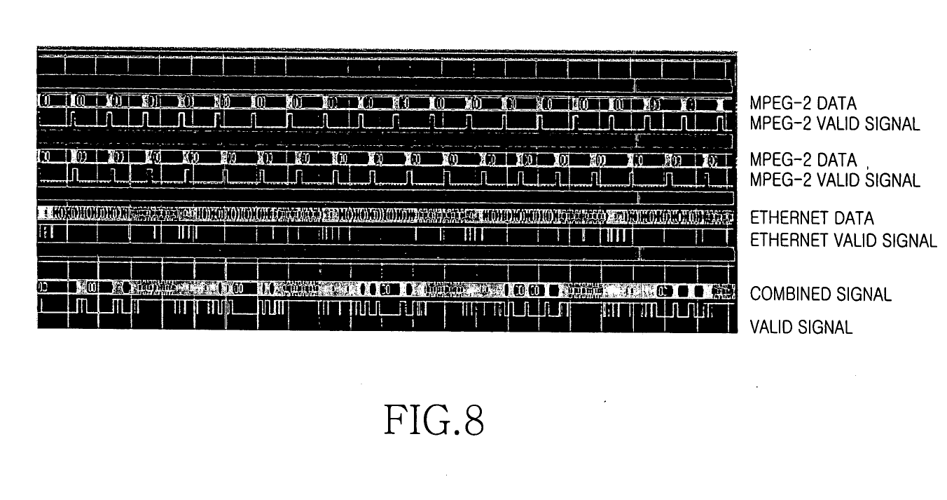

FIG. 8 is a graph illustrating a form of data acquired by components shown in FIG. 7. When MPEG-2 data and Ethernet data are input, the FPGA ASI multiplexer 160 of the transmitting side multiplexes the MPEG-2 data and the Ethernet data according to valid signals and then outputs a result of the multiplexing step.

When receiving data units, the FPGA ASI demultiplexer 220 of the receiving side shown in FIG. 7 classifies the received data units according to IDs inserted thereinto. At this point, the FPGA ASI demultiplexer 220 of the receiving side sends the MPEG-2 data to the DVB ASI reception interface 230 or varies a transmission rate of the data using a predetermined transmission rate-related scheme to send the data at a different transmission rate. The FPGA ASI demultiplexer 220 of the receiving side varies and transmits voice data at an actual data rate.

Furthermore, the FPGA ASI demultiplexer 220 of the receiving side adds 4 bytes to a preamble of the Ethernet data to maintain the IFG. The Ethernet data is valid when the preamble is of 2 bytes or more. According to the decreased number of bytes added to the preamble, an IFG area can be increased in comparison with an actual IFG.

The FPGA ASI demultiplexer 220 of the receiving side again checks an FCS for the received Ethernet data and determines whether or not an error has been incurred for a transmission time.

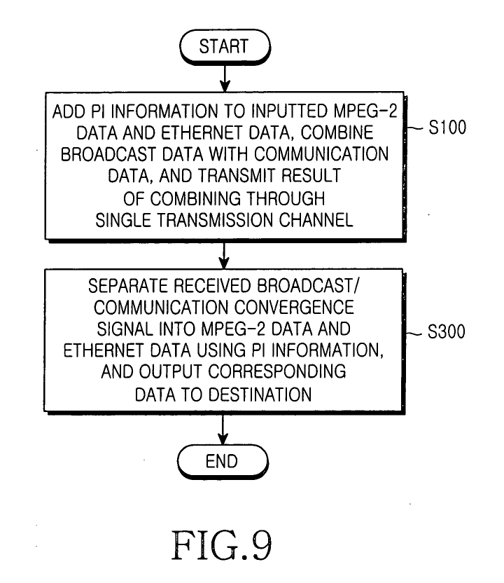

Now, a method for transmitting and receiving the broadcast/communication convergence signal will be described with reference to FIG. 9. FIG. 9 is a flow chart illustrating a method for transmitting and receiving a broadcast/communication convergence signal using a system for performing transmission and reception operations based on broadcast/communication convergence equipped with a transmitter and a receiver in accordance with an aspect of the present invention.

First, the transmitter adapted for broadcast/communication convergence converts input broadcast data into a parallel format, adds packet identification (PID) information to each of the broadcast data based on the parallel format and input communication data, or respective data packets, and multiplexes the broadcast data with the communication data, such that a multiplexed broadcast/communication convergence signal is transmitted through a single transmission channel (S100).

When receiving the broadcast/communication convergence signal, the receiver adapted for broadcast/communication convergence separates the received broadcast/communication convergence signal into MPEG-2 data and Ethernet data using the PID information, and outputs corresponding data to a destination (S300).

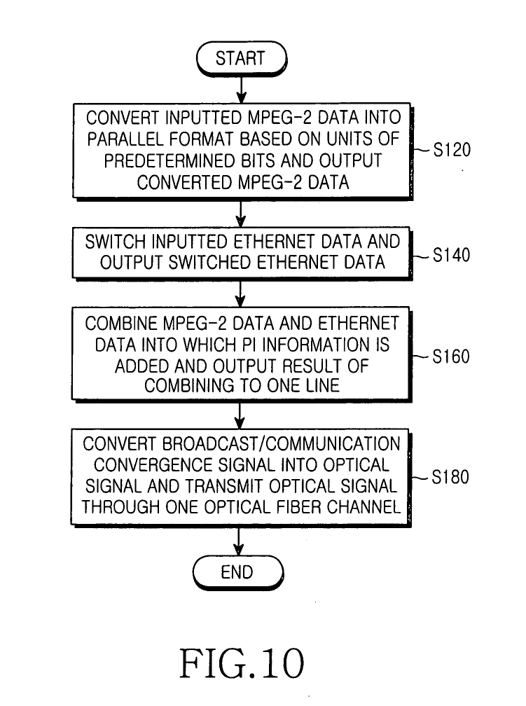

An output operation for outputting the broadcast/communication convergence signal in the transmitter adapted for broadcast/communication convergence will be described in detail with reference to FIG. 10, a flow chart illustrating a detailed process of step S100 shown in FIG. 9.

First, the DVB ASI transmission interface 100 converts input MPEG-2 data into a parallel format based on units of predetermined bits, and outputs the converted MPEG-2 data to a plurality of output ports (S120).

The Ethernet transmission switch 140 switches Ethernet data transmitted from an Ethernet physical layer 120 and then outputs the switched Ethernet data (S140). The FPGA ASI multiplexer 160 adds PI (Port Identification) information to the data packet starting portion of each of the MPEG-2 data and the Ethernet data output from the DVB ASI transmission interface 100 and the Ethernet transmission switch 140. At this point, the FPGA ASI multiplexer 160 multiplexes the MPEG-2 data and the Ethernet data to which the PI information is added and then outputs a multiplexed broadcast/communication convergence signal (S160).

The optical transmission interface 180 converts the multiplexed broadcast/communication convergence signal output from the FPGA ASI multiplexer 160 into an optical signal and then transmits the optical signal to a destination through one optical fiber channel 200 (S180).

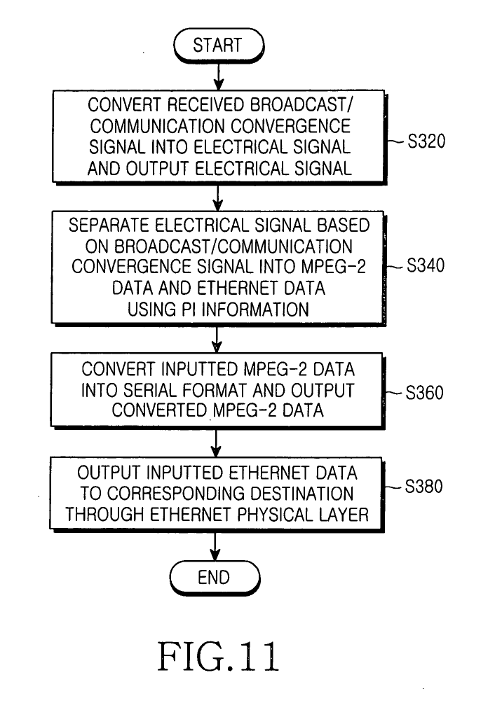

A process operation of the broadcast/communication convergence signal received in the receiver adapted for broadcast/communication convergence will be described in detail with reference to FIG. 11, a flow chart illustrating a detailed process of step S300 shown in FIG. 9.

First, when the optical reception interface 210 receives the broadcast/communication convergence signal transmitted from the optical transmission interface 180 of the transmitter, it converts the received broadcast/communication convergence signal into an electrical signal (S320).

The FPGA ASI demultiplexer 220 separates the electrical signal based on the broadcast/communication convergence signal output from the optical reception interface 210 into MPEG-2 data and Ethernet data using PID information. At this point, the FPGA ASI demultiplexer 220 outputs the MPEG-2 data and Ethernet data through a plurality of different output ports (S340).

The DVB ASI reception interface 230 converts the MPEG-2 data output from the FPGA ASI demultiplexer 220 into a serial format and then outputs the converted MPEG-2 data to a corresponding destination (S360). The Ethernet reception switch 250 transmits the Ethernet data output from the FPGA ASI demultiplexer 220 to a corresponding destination through the Ethernet physical layer 260 (S380).

On the other hand, after separating the broadcast/communication convergence signal into the MPEG-2 data and the Ethernet data using the PI information at the above step S340, the FPGA ASI demultiplexer 220 removes the PI information added to each of the MPEG-2 data and the Ethernet data. Thus, the FPGA ASI demultiplexer 220 outputs, through the output ports, the MPEG-2 data and the Ethernet data from which the PID information is removed.

As mentioned above, even though methods for transmitting and receiving the broadcast/communication convergence signal have been described based on MPEG-2 data of broadcast data in FIGS. 9 to 11, they can be implemented based on IP/Ethernet/data over MPEG-2, MPEG-4 data, H.264 data of MPEG-4 AVC, data using an MPEG-2 system standard, and multimedia data requiring QoS guarantee.

As is apparent from the above description in accordance with the present invention, the transmitting side inserts PID information necessary for discriminating a type of data into each of the broadcast data and the communication data, muliplexes the broadcast data and the communication data into which the PID information units are inserted in one signal, and transmits the multiplexed signal through a single transmission line or channel. Then, the receiving side separates the multiplexed signal into the broadcast data and the communication data using the PI information and outputs each of the broadcast data and the communication data to a corresponding destination. Thus, the broadcast data and the communication data can be simultaneously received and transmitted through the single transmission line or channel.

In accordance with the present invention, the Ethernet data can be transmitted through 100 Mbps Fast Ethernet, a plurality of Fast Ethernet or Gibabit Ethernet (GbE), and various transmission methods and transmission rates can be implemented as a physical layer of an optical channel method including DVB ASI protocol. Since a transmission chipset of a physical layer uses external clocks, transmission rates can be flexibly changed according to transmission distance and usage. Although the aspects of the present invention have been disclosed for illustrative purposes, those skilled in the art will appreciate that various modifications, additions and substitutions are possible, without departing from the scope of the invention. Therefore, the present invention is not limited to the above-described aspects and drawings.

1. A system for performing transmission and reception operations based on broadcast/communication convergence, comprising:
a transmitter adapted for the broadcast/communication convergence for converting an input broadcast data into a parallel format, adding port identification information to the broadcast data converted into the parallel format and Ethernet data, multiplexing the broadcast data and the Ethernet data, and transmitting a multiplexed broadcast/communication convergence signal based on a result of the multilplexing through a single transmission channel; and
a receiver adapted for the broadcast/communication convergence for demultiplexing the multiplexed broadcast/communication convergence signal using the port identification information to be separated into the broadcast data and the Ethernet data when the multiplexed broadcast/communication convergence signal is received, and outputting the broadcast data and the communication data to a corresponding destination.

2. The system as set forth in claim 1, wherein transmitter comprises:
a transmission interface for converting the input broadcast data into a parallel format based on units of predetermined bits, and outputting the converted data to a plurality of ports;
an Ethernet transmission switch for performing a switching operation to output the Ethernet data transmitted from a data communication physical layer;
a Field Programmable Gate Array multiplexer for adding the port identification information to each of the broadcast data and the Ethernet data output from the transmission interface and the Ethernet transmission switch, multiplexing the broadcast data and the Ethernet data, each of which has the port identification information added thereto, and outputting the multiplexed broadcast/communication convergence signal;
a physical layer transmission part for converting the multiplexed broadcast/communication convergence signal into serial data using a high speed serial standard physical layer; and
an optical transmission interface for transmitting the serial data to a destination through one transmission channel.

3. The system as set forth in claim 2, wherein the fast serial standard physical layer is a fiber channel.

4. The system as set forth in claim 2, wherein the physical layer transmission part uses one of a fiber channel, an Enterprise Systems Connection channel, and a digital video broadcast-asynchronous serial interface.

5. The system as set forth in claim 2, wherein the physical layer transmission part selectively changes a transmission rate by changing external clock signals supplied to the transmission part.

6. The system as set forth in claim 1, wherein the receiver adapted for the broadcast/communication convergence comprises:
an optical reception interface for converting the multiplexed broadcast/communication convergence signal received from the transmitter adapted for the broadcast/communication convergence into an electrical signal, and outputting the electrical signal;
a physical layer reception part for converting the electrical signal corresponding to the multiplexed broadcast/communication convergence signal output from the optical reception interface into a parallel format;
an FPGA demultiplexer for demultiplexing the data converted into the parallel format to be separated into broadcast data and Ethernet data using the port identification information, and outputting the broadcast data and the Ethernet data through respective output ports based on the port identification information;
a reception interface for converting the broadcast data output from the Field Programmable Gate Array demultiplexer into a serial format, and outputting the converted data in the serial format to a first corresponding destination; and
an Ethernet reception switch for outputting the Ethernet data output from the Field Programmable Gate Array demultiplexer to a second corresponding destination through the data communication physical layer.

7. The system as set forth in claim 6, wherein the Field Programmable Gate Array demultiplexer separates the broadcast/communication convergence signal into the broadcast data and the Ethernet data using the port identification information, removes the port identification information from each of the broadcast data and the Ethernet data, and outputs the broadcast data and the Ethernet data, each of which does not include the port identification information added thereto, to the reception interface and the Ethernet reception switch.

8. The system as set forth in claim 1, wherein the broadcast data is one of MPEG-2 data, MPEG-4 data, H.264 data of MPEG-4 AVC, and IP/Ethernet/data over MPEG-2.

9. The system as set forth in claim 1, wherein the broadcast data uses a MPEG-2 system layer.

10. The system as set forth in claim 1, wherein the Ethernet data is one of a plurality of 100 Mbps Fast Ethernets, and a Gigabit Ethernet (GbE).

11. The system as set forth in claim 1, wherein the transmitter comprises:
a digital video broadcast-asynchronous serial interface for converting the input broadcast data into the parallel format based on predetermined bits and outputting the converted broadcast data through a plurality of output ports;
a communication switch for switching the communication data transmitted from a data communication physical layer and outputting the switched communication data;
a field programmable gate array asynchronous serial interface multiplexer for inserting the port identification information into the header of each of the broadcast data and the communication data output from the digital video broadcast-asynchronous serial interface and the communication switch, multiplexing the broadcast data and the communication data into which the port identification information is inserted, and outputting the broadcast/communication convergence signal based on the result of the multiplexing; and
an optical transmission interface for converting the broadcast/communication convergence signal into an optical signal and transmitting the optical signal to a destination through the single transmission channel.

12. The system as set forth in claim 1, wherein the receiver comprises:
an optical reception interface for receiving the broadcast/communication convergence signal transmitted from the transmitter adapted for the broadcast/communication convergence, converting the received broadcast/communication convergence signal into an electrical signal and outputting the electrical signal;
a field programmable gate array-asynchronous serial interface demultiplexer for separating the electrical signal based on the broadcast/communication convergence signal into the broadcast data and the communication data using the port identification information, and outputting the broadcast data and the communication data through a plurality of different output ports;
a digital video broadcast-asynchronous serial interface for converting the broadcast data output from the field programmable gate array-asynchronous serial interface demultiplexer into a serial format, and outputting the converted broadcast data to a corresponding destination; and
an Ethernet switch for outputting the communication data output from the field programmable gate array-asynchronous serial interface demultiplexer to a corresponding destination through a data communication physical layer.

13. The system as set forth in claim 12, wherein the field programmable gate array-asynchronous serial interface demultiplexer separates the broadcast/communication convergence signal into the broadcast data and the communication data using the port identification information, and removes the port identification information inserted into each of the broadcast data and the communication data, and outputs to the digital video broadcast-asynchronous serial interface and the Ethernet switch, the broadcast data and the communication data from which the port identification information is removed.

14. A method for transmitting and receiving a broadcast/communication convergence signal using a system for performing transmission and reception operations based on broadcast/communication convergence, the system being equipped with a transmitter and receiver based on the broadcast/communication convergence, comprising the steps of:
(a) converting input broadcast data into a parallel format by a transmitter adapted for broadcast/communication convergence, inserting port identification information into each of the broadcast data converted into the parallel format and input communication data, multiplexing the broadcast data and the communication data, and transmitting a broadcast/communication convergence signal based on a result of the multiplexing through a single transmission channel; and
(b) demultiplexing the broadcast/communication convergence signal, using the port identification information, to be separated into the broadcast data and the communication data by a receiver adapted for receiving the broadcast/communication convergence when the broadcast/communication convergence signal is received, and outputting data to a corresponding destination.

15. The method as set forth in claim 14, wherein the step (a) further comprises:
converting the input broadcast data into the parallel format based on predetermined bits, and outputting the converted broadcast data through a plurality of output ports;
switching the communication data transmitted from a data communication physical layer and outputting the switched communication data;
inserting the port identification information into each of the output broadcast data and communication data, multiplexing the broadcast data and the communication data into which the port identification information is inserted, and outputting the broadcast/communication convergence signal based on the result of the multiplexing; and
converting the broadcast/communication convergence signal into an optical signal and transmitting the optical signal to a destination through the single transmission channel.

16. The method as set forth in claim 14, wherein the step (b) further comprises:
receiving the broadcast/communication convergence signal transmitted from the transmitter, converting the received broadcast/communication convergence signal into an electrical signal, and outputting the electrical signal;
separating the electrical signal based on the broadcast/communication convergence signal into the broadcast data and the communication data using the port identification information, and outputting the broadcast data and the communication data through a plurality of different output ports;
converting the output broadcast data into a serial format, and outputting the converted broadcast data to a corresponding destination; and
outputting the communication data to a corresponding destination through the data communication physical layer.

17. The method as set forth in claim 16, wherein the port identification information is removed from the broadcast data and the communication data when the broadcast data and the communication data are separated from each other using the port identification information and a result of the separation is output, and the broadcast data and the communication data from which the port identification information is removed are output through the output ports, respectively.

18. The method as set forth in claim 14, wherein the broadcast data is one of MPEG-2 data, MPEG-4 data, H.264 data as MPEG-4 AVC, and IP/Ethernet/data over MPEG-2.

19. The method as set forth in claim 1, wherein the broadcast data uses a MPEG-2 system layer.

20. The method as set forth in claim 14, wherein the communication data is Ethernet data.

21. The system as set forth in claim 20, wherein the Ethernet data is one of a plurality of 100 Mbps Fast Ethernets, and a Gigabit Ethernet (GbE).
